(19) United States
(12) Patent Application Publication
(10) Pub. No.: US 2024/0070342 A1
(43) Pub. Date: Feb. 29, 2024

(54) DESIGN METHOD FOR ALLOWABLE COMPRESSIVE STRESS OF AXIALLY COMPRESSED CYLINDER

(71) Applicant: ZHEJIANG UNIVERSITY, Hangzhou (CN)

(72) Inventors: Zhiping CHEN, Hangzhou (CN); Peng JIAO, Hangzhou (CN); Hao MIAO, Hangzhou (CN); Haiyang OU, Hangzhou (CN); Yao ZHU, Hangzhou (CN)

(21) Appl. No.: 18/493,794

(22) Filed: Oct. 24, 2023

Related U.S. Application Data
(63) Continuation of application No. PCT/CN2022/133625, filed on Nov. 23, 2022.

(30) Foreign Application Priority Data
Apr. 29, 2022 (CN) 202210475360.1

(51) Int. Cl. G06F 30/17

(52) U.S. Cl. CPC G06F 30/17; G06F 2119/14

(57) ABSTRACT

The present disclosure relates to the field of a stability design of pressure vessels and main bearing members of nuclear engineering, and discloses a new design method for an allowable compressive stress of an axially compressed cylinder. By introducing elastic-plastic influence parameters and cylinder structure characteristic parameters, a critical buckling stress values of axially compressed cylinders under different buckling failure modes and a critical buckling stress reduction factor considering the influence of initial defects are obtained. At the same time, a design safety factor of the axially compressed cylinder is given, and a new calculation flow for the allowable compressive stress of the axially compressed cylinder is put forward. The present method is of great significance to promote the development of large-scale and lightweight axially compressed cylinders in engineering.

### CROSS-REFERENCE TO RELATED APPLICATIONS

The present application is a continuation of International Application No. PCT/CN2022/133625, filed on Nov. 23, 2022, which claims priority to Chinese Application No. 202210475360.1, filed on Apr. 29, 2022, the contents of both of which are incorporated herein by reference in their entireties.

### TECHNICAL FIELD

The present disclosure relates to the fields of pressure vessels, nuclear engineering and the like, in particular to a design method for the allowable compressive stress of an axially compressed cylinder.

### BACKGROUND

A cylindrical shell (a cylinder for short) is an important basic part of a pressure vessel, which is widely used in pressure vessels and nuclear engineering because of its efficient bearing performance. Typical cylinders, such as large oil storage tanks, tower cylinders, nuclear containments and the like are prone to buckling failure under the working conditions of earthquake, storage , discharge and equipment lifting, and buckling is the most important failure mode. Therefore, for the large-scale axially compressed cylindrical structure in practical engineering, axial pressure buckling is the failure factor that must be considered in the design process. Among them, the calculation of the allowable compressive stress of an axially compressed cylinder is the most important in design.

At present, although the current domestic and international codes and standards such as GB/T 150.1, ASME BPVC VIII-1, ASME BPVC VIII-2, ASME III-NB and EN 13445-3 all provide corresponding provisions for the design value of allowable compressive stress of axially compressed cylinders, and put forward various design methods of allowable compressive stress of axially compressed cylinders. However, most of these methods use line graphs or buckling analysis methods based on elastic theory, without fully considering the influence of elastic-plastic properties, structural characteristics and boundary conditions of axially compressed cylinder materials at the same time, and give the calculation methods of critical compressive stress of axially compressed cylinders based on different buckling failure modes. In addition, the design method of allowable compressive stress of axially compressed cylinders in the current domestic and foreign standard specifications does not fully consider the defect sensitivity of cylinder shells. As we all know, there is a significant difference between the actual critical buckling stress of an axially compressed cylinder structure and the theoretical calculation value of an ideal elastic cylinder. The former is usually only 20%-50% of the latter, and it is very dispersive. The research shows that the high sensitivity of an axially compressed cylinder to initial defects is the fundamental reason for this phenomenon. To characterize the sensitivity of initial defects of axially compressed cylinders, it is often necessary to introduce the concept of load reduction factor ρ_{KDF} in practical engineering design. This factor is defined as the ratio of the critical buckling stress of a real cylinder structure under axial pressure to the critical buckling stress calculated by ideal cylinder theory, which is a coefficient greater than 0 and less than 1. In the design of cylinder structure, the product of the load reduction factor and the critical buckling stress of an ideal axially compressed cylinder is usually taken as the allowable critical buckling stress of the axially compressed cylinder. Therefore, one of the core problems in buckling design of an axially compressed cylinder structure is to determine a reasonable buckling stress reduction factor, accurately consider the sensitivity of initial defects of the cylinder, and give a reliable buckling stress reduction factor, which is the premise of accurately predicting the critical buckling stress of a real axially compressed cylinder and the key to establishing a reasonable, safe and economical allowable compressive stress design method for axially compressed cylinders.

At the same time, with the improvement of cylinder processing technology, the renewal of material system and the rich experience of quality control, the existing design methods for the allowable compressive stress of an axially compressed cylinder often lead to conservative design results, which cannot meet the needs of large-scale and lightweight development of cylinder structures in the fields of pressure vessels and nuclear engineering in China. Therefore, it is urgent to establish a new and more reasonable and perfect design method for the allowable compressive stress of an axially compressed cylinder.

### SUMMARY

Because of the problems that the design method for the allowable compressive stress of axially compressed cylinders in the current domestic and international standards and specifications is high in calculation cost and too conservative, the present disclosure provides a new design method for an allowable compressive stress of an axially compressed cylinder. By introducing elastic-plastic influence parameters and cylinder structure characteristic parameters, the critical buckling stress values of the axially compressed cylinder under different buckling failure modes and the critical buckling stress reduction factor considering the influence of initial defects are obtained. At the same time, the safety factor of the axially compressed cylinder design is given, and a new calculation flow for an allowable compressive stress of the axially compressed cylinder is put forward. Compared with the existing methods, the present disclosure improves the calculation accuracy and reduces the design redundancy; the calculation formula is more direct, avoiding the iterative calculation of tangent modulus, and the design process is simple, efficient and advanced; Meanwhile, it has sufficient safety margin. The preset method is of great significance in promoting the development of large-scale and lightweight axially compressed cylinders in engineering.

The technical solution adopted by the present disclosure is as follows: a design method of allowable compressive stress of an axially compressed cylinder is provided, which specifically includes the following steps:

S1, determining structural characteristic parameters and material performance parameters of the cylinder according to design requirements.

The structural characteristic parameters comprise a radius R, a length L and a thickness t; the material performance parameters comprise an elastic modulus E, a Poisson's ratio v and a yield strength R_{eL}.

S2, calculating a value of a parameter η representing the structural characteristics of the axially compressed cylinder.

$$η = \frac{L}{R} \sqrt{\frac{R}{t}}$$

S3, calculating a theoretical value σ_{cr} of an ideal elastic buckling stress of the axially compressed cylinder according to the value of η in step S2.

For a short cylinder with η≤1.7, the theoretical value σ_{cr} of the buckling stress is calculated according to the following formula:

$${σ}_{cr} = \frac{0 \text{.79} - \frac{1.06}{η} + \frac{1.2}{{η}^{2}}}{\sqrt{( 1 - {v}^{2} )}} E \frac{t}{R}$$

For a medium-long cylinder with 1.7<η≤0.5R/t, the theoretical value σ_{cr} of the buckling stress is calculated as follows:

$${σ}_{cr} = \frac{0.577}{\sqrt{( 1 - {v}^{2} )}} E \frac{t}{R}$$

For a long cylinder with η>0.5R/t the theoretical value σ_{cr} of the buckling stress is calculated as follows:

$${σ}_{c r} = \frac{0.577}{\sqrt{( 1 - {v}^{2} )}} E \frac{t}{R} \cdot {B}_{x}$$

$$where {B}_{x} = max ( 1 + \frac{0.2}{{B}_{x b}} ( 1 - \frac{2 L {t}^{0.5}}{{R}^{1.5}} ) , 0.6 )$$

where B_{xb} is a coefficient considering the influence of cylinder boundary conditions.

S4, calculating a value of a parameter γ representing an elastic-plastic behavior of the axially compressed cylinder;

$$γ = \sqrt{3 ( 1 - {v}^{2} )} \frac{{R}_{e L}}{E \frac{R}{t}}$$

S5, calculating a critical buckling stress σ_{acr}^{U} of the axially compressed cylinder under different buckling failure modes considering the influence of material elasticity and structural length-diameter ratio.

For a cylinder with plastic buckling of γ≤0.2, the σ_{acr}^{U} value is calculated according to the following formula.

σ_{acr}^{U}=σ_{cr}·γ

For a cylinder with elastic-plastic buckling of 0.2<γ≤1.2, the σ_{acr}^{U} value is calculated according to the following formula.

σ_{acr}^{U}=σ_{cr}·(−0.01982+1.12391·γ−0.25422·γ²)

For a cylinder with elastic buckling of γ>1.2, the σ_{acr}^{U} value is calculated according to the following formula.

$${σ}_{acr}^{U} = {σ}_{c r} \cdot ( 1.012 + 2.226 \cdot {e}^{- \frac{η}{2.220}} )$$

S6, calculating the values of structural characteristic boundary points η_{E} and η_{P} when the cylinder undergoes plastic buckling, elastic-plastic buckling and elastic buckling.

$${η}_{E} = 0 \text{.832} \cdot \sqrt{\frac{1}{\sqrt{( 1 - {v}^{2} )}} \frac{{L}^{2}}{{R}^{2}} \frac{E}{{R}_{e L}}}$$

$${η}_{P} = 0 \text{.340} \cdot \sqrt{\frac{1}{\sqrt{( 1 - {v}^{2} )}} \frac{{L}^{2}}{{R}^{2}} \frac{E}{{R}_{e L}}}$$

S7, determining a buckling stress reduction factor calculation model ρ_{KDF} selected for the cylinder considering the influence of initial defects according to the η value.

For a cylinder with η>η_{E}, the ρ_{KDF} value is calculated according to the following formula.

ρ_{KDF}=0.40535+0.60158·e^{-0.06749·η}

For a cylinder with η_{P}<η≤η_{E}, the ρ_{KDF} value is calculated according to the following formula.

$${ρ}_{KDF} = f ( {η}_{E} ) + \frac{{η}_{E} - η}{{η}_{E} - {η}_{P}} [ f ( {η}_{P} ) - f ( {η}_{E} ) ]$$

$$where f ( {η}_{E} ) = 0.40535 + 0.60158 \cdot {e}^{0.06749 \cdot {η}_{E}} ; f ( {η}_{P} ) = 0.9 .$$

For a cylinder with η≤η_{P}, ρ_{KDF}=0.9.

S8, calculating an allowable compressive stress value [σ_{acr}] of the axially compressed cylinder according to the ideal critical buckling stress σ_{acr}^{U} considering the influence of material elasticity and structural length-diameter ratio, and the critical buckling stress reduction factor ρ_{KDF} and the design safety factor n_{ab} considering the influence of initial defects as follows:

$$[ {σ}_{acr} ] = \frac{{σ}_{acr}^{U} \cdot {ρ}_{KDF}}{{n}_{ab}} .$$

The design safety factor n_{ab} is 2.0.

Further, in S3, B_{xb} is a coefficient considering the influence of cylinder boundary conditions, and B_{xb}=1 when both ends of the cylinder are simply supported, B_{xb}=3 when one end is simply supported and one end is fixed, and B_{xb}=6 when both ends are fixed.

Furthermore, a diameter-thickness ratio range of the cylinder is

$$5 \leq \frac{R}{t} \leq 1200 .$$

Furthermore, a length-diameter ratio range of the cylinder is

$$0.5 \leq \frac{L}{R} \leq 15 .$$

Furthermore, a material of the cylinder is a metal material or a composite material.

The present disclosure has the following beneficial effects.

Compared with that existing design method, the present disclosure has a clear physical meaning and a more efficient and convenient application; the calculation accuracy is improved, and the design redundancy is reduced; the calculation formula is more direct, and the design process is simple, efficient and advanced. At the same time, it has enough safety margin and is suitable for practical engineering design. To sum up, the design method for an allowable compressive stress of an axially compressed cylinder proposed by the present disclosure will play an important role in the lightweight design of large cylindrical structures in the fields of pressure vessels and nuclear engineering and has important engineering application value.

### BRIEF DESCRIPTION OF DRAWINGS

FIG. 1 is a flow chart of an allowable compressive stress design method for an axially compressed cylinder of the present disclosure.

### DESCRIPTION OF EMBODIMENTS

The present disclosure will be further described in detail with the attached drawings and examples. It should be understood that the specific embodiments described here are only used to explain, rather than to limit the present disclosure, and the drawings only show the contents related to the specific embodiments, not the whole contents of the present disclosure.

### EXAMPLE 1

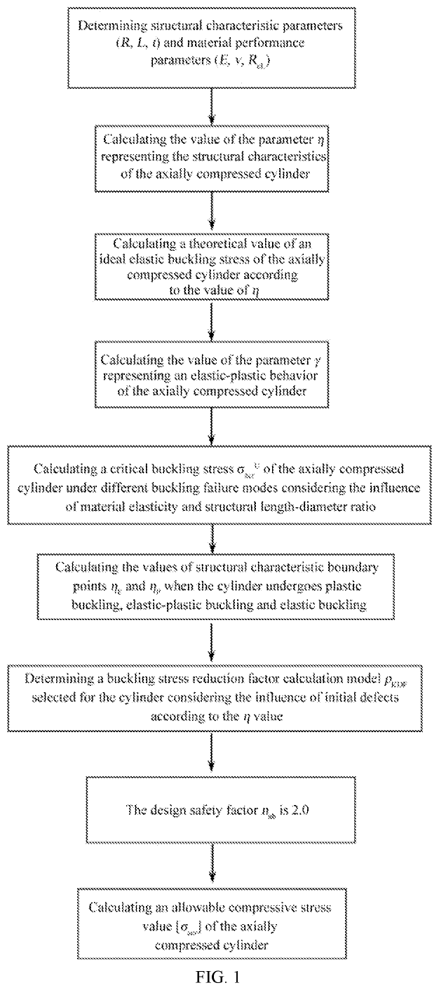

Referring to FIG. 1, a design method for an allowable compressive stress of an axially compressed cylinder includes the following steps.

In S1, structural characteristic parameters and material performance parameters of the cylinder are determined according to design requirement; the structural characteristic parameters comprise a radius R=500 mm, a length L=560 mm and a thickness t=1.20 mm; the material performance parameters comprise an elastic modulus E=210 GPa, a Poisson's ratio v=0.3 and a yield strength R_{eL}=280 MPa.

In S2, a value of a parameter η representing the structural characteristics of the axially compressed cylinder is calculated;

$$η = \frac{L}{R} \sqrt{\frac{R}{t}} = 22.9$$

In S3, a theoretical value σ_{cr} of ideal elastic buckling stress of the axially compressed cylinder is calculated according to the value of η in step S2; for a medium-long cylinder with 1.7<η≤0.5R/t, the theoretical value σ_{cr} of the buckling stress is calculated as follows:

$${σ}_{cr} = \frac{0.577}{\sqrt{( 1 - {V}^{2} )}} E \frac{t}{R} = 30 5. MPa$$

In S4, a value of parameter γ representing an elastic-plastic behavior of the axially compressed cylinder is calculated.

$$γ = \sqrt{3 ( 1 - {v}^{2} )} \frac{{R}_{e L}}{E \frac{R}{t}}$$

In S5, a critical buckling stress σ_{acr}^{U} of the axially compressed cylinder under different buckling failure mode considering the influence of material elasticity and structural length-diameter ratio is calculated; for a cylinder with elastic-plastic buckling of 0.2<γ≤1.2, the σ_{acr}^{U} value is calculated according to the following formula.

σ_{acr}^{U}=σ_{cr}·(−0.01982+1.12391·γ−0.25422·γ²)=243.3 MPa

In S6, the values of structural characteristic boundary points η_{E}, and η_{P} when the cylinder undergoes plastic buckling, elastic-plastic buckling and elastic buckling are calculated.

$${η}_{E} = 0 \text{.832} \cdot \sqrt{\frac{1}{\sqrt{( 1 - {v}^{2} )}} \frac{{L}^{2}}{{R}^{2}} \frac{E}{{R}_{e L}}}$$

$${η}_{P} = 0 \text{.340} \cdot \sqrt{\frac{1}{\sqrt{( 1 - {v}^{2} )}} \frac{{L}^{2}}{{R}^{2}} \frac{E}{{R}_{e L}}}$$

In S7, a buckling stress reduction factor calculation model σ_{KDF} selected for the cylinder considering the influence of initial defects is judged according to the η value; for a cylinder with η_{P}<η≤η_{E}, the ρ_{KDF} value is calculated according to the following formula.

$${ρ}_{KDF} = f ( {η}_{E} ) + \frac{{η}_{E} - η}{{η}_{E} - {η}_{P}} [ f ( {η}_{P} ) - f ( {η}_{E} ) ] = 0.591$$

In S8, an allowable compressive stress value [σ_{acr}] of the axially compressed cylinder is calculated according to the ideal critical buckling stress σ_{acr}^{U} considering the influence of material elasticity and structural length-diameter ratio, and the critical buckling stress reduction factor ρ_{KDF} and the design safety factor n_{ab} considering the influence of initial defects as follows:

$$[ {σ}_{acr} ] = \frac{{σ}_{acr}^{U} \cdot {ρ}_{KDF}}{{n}_{ab}} = \frac{243.3 \times 0.591}{2} = 71.9 MP a .$$

The design safety factor n_{ab} is 2.0.

The comparison between the allowable compressive stress design value and the test value of the axially compressed cylinder given in this example is shown in Table 1.

TABLE 1
Comparison of allowable compressive stress design value and test
value of axially compressed cylinder given in this example

| | | Present | ASMEVIII-2 | EN |
|---|---|---|---|---|
| Method | Test | disclosure | Part 4 | 13445-3 |
| Allowable compressive | 180.2 | 71.9 | 40.1 | 25.5 |
| stress design value of the | | | | |
| cylinder | | | | |
| Relative error | — | −60.1% | −77.8% | −85.8% |

It should be noted that in the design of a cylindrical structure in practical engineering, in order to ensure the safety of the structural design, a safety factor must be introduced into the design method. The allowable compressive stress value of each axially compressed cylinder in Table 1 is the design value given after considering the design safety factor of each method. Taking the present disclosure as an example, by considering the design safety factor n_{ab}=2.0 of the axially compressed cylinder, the error between the design value of the allowable compressive stress of the axially compressed cylinder and the test value exceeds 50%. It should be noted that, in this case, it does not mean a large method error, but an inevitable result after considering the design safety factor.

As can be seen from Table 1, compared with the design methods given by the other two current standards and specifications, the error between the allowable compressive stress design value and the test value of the axially compressed cylinder determined by the present disclosure is the smallest, and the design redundancy is effectively reduced. At the same time, it has enough safety margin and meets the needs of engineering design.

### EXAMPLE 2

Referring to FIG. 1, a design method for a allowable compressive stress of an axially compressed cylinder includes the following steps:

In S1, structural characteristic parameters and material performance parameters of the cylinder are determined according to design requirement; the structural characteristic parameters comprise a radius R=500 mm, a length L=600 mm and a thickness t=1.50 mm; the material performance parameters comprise an elastic modulus E=76.169 GPa, a Poisson's ratio v=0.3 and a yield strength R_{eL}=340 MPa.

In S2, a value of a parameter η representing the structural characteristics of the axially compressed cylinder is calculated.

$$η = \frac{L}{R} \sqrt{\frac{R}{t}} = 21.91$$

In S3, a theoretical value σ_{cr} of an ideal elastic buckling stress of the axially compressed cylinder is calculated according to the value of η in step S2; for a medium-long cylinder with 1.7<η≤0.5R/t, the theoretical value σ_{cr} of the buckling stress is calculated as follows:

$${σ}_{cr} = \frac{0.577}{\sqrt{( 1 - {v}^{2} )}} E \frac{t}{R} = 138.3 MPa$$

In S4, a value of parameter γ representing an elastic-plastic behavior of the axially compressed cylinder is calculated.

$$γ = \sqrt{3 ( 1 - {v}^{2} )} \frac{{R}_{e L}}{E \frac{R}{t}}$$

In S5, a critical buckling stress to σ_{acr}^{U} of the axially compressed cylinder under different buckling failure modes considering the influence of material elasticity and structural length-diameter ratio is calculated; for a cylinder with elastic-plastic buckling of γ>1.2, the σ_{acr}^{U} value is calculated according to the following formula.

$${σ}_{acr}^{U} = {σ}_{cr} \cdot ( 1.012 + 2.226 \cdot {e}^{- \frac{η}{2.220}} ) = 140. MPa$$

In S6, the values of structural characteristic boundary points η_{E} and η_{P} when the cylinder undergoes plastic buckling, elastic-plastic buckling and elastic buckling are calculated.

$${η}_{E} = 0 \text{.832} \cdot \sqrt{\frac{1}{\sqrt{( 1 - {v}^{2} )}} \frac{{L}^{2}}{{R}^{2}} \frac{E}{{R}_{e L}}}$$

$${η}_{P} = 0 \text{.340} \cdot \sqrt{\frac{1}{\sqrt{( 1 - {v}^{2} )}} \frac{{L}^{2}}{{R}^{2}} \frac{E}{{R}_{e L}}}$$

In S7, a buckling stress reduction factor calculation model ρ_{KDF} selected for the cylinder considering the influence of initial defects is judged according to the η value; for a cylinder with η>η_{E}, the ρ_{KDF} value is calculated according to the following formula.

ρ_{KDF}=0.40535+0.60158·e^{-0.06749·η}=0.542

In S8, an allowable compressive stress value [σ_{acr}] of the axially compressed cylinder is calculated according to the ideal critical buckling stress σ_{acr}^{U} considering the influence of material elasticity and structural length-diameter ratio, and the critical buckling stress reduction factor ρ_{KDF} and the design safety factor n_{ab} considering the influence of initial defects as follows:

$$[ {σ}_{acr} ] = \frac{{σ}_{acr}^{U} \cdot {ρ}_{KDF}}{{n}_{ab}} = \frac{140.0 \times 0.542}{2} = 3 7.9 MPa$$

The design safety factor n_{ab} is 2.0.

The comparison between the allowable compressive stress design value and the test value of the axially compressed cylinder given in this example is shown in Table 2.

TABLE 2
Comparison of allowable compressive stress design value and
test value of axially compressed cylinder given in this example

| | | Present | ASMEVIII-2 | EN |
|---|---|---|---|---|
| Method | Test | disclosure | Part 4 | 13445-3 |
| Allowable compressive | 79.2 | 35.0 | 22.1 | 24.9 |
| stress value of the | | | | |
| cylinder | | | | |
| Relative error | — | −52.1% | −72.1% | −68.5% |

It should be noted that in the design of cylindrical structures in practical engineering, to ensure the safety of structural design, a safety factor must be introduced into the design method. The allowable compressive stress value of each axially compressed cylinder in Table 2 is the design value given after considering the design safety factor of each method. Taking the present disclosure as an example, by considering the design safety factor n_{ab}=2.0 of the axially compressed cylinder, the error between the design value of the allowable compressive stress of the axially compressed cylinder and the test value exceeds 50%, but this does not mean that the method error is large, but it is an inevitable result after considering the design safety factor.

As can be seen from Table 2, compared with the design methods given by the other two current standards and specifications, the error between the allowable compressive stress design value and the test value of the axially compressed cylinder determined by the present disclosure is the smallest, and the design redundancy is effectively reduced. At the same time, it has enough safety margin and meets the needs of engineering design.

### EXAMPLE 3

Referring to FIG. 1, a design method for an allowable compressive stress of an axially compressed cylinder includes the following steps:

In S1, structural characteristic parameters and material performance parameters of the cylinder are determined according to design requirement; the structural characteristic parameters comprise a radius R=50 mm, a length L=113.1 mm and a thickness t=0.5 mm; the material performance parameters comprise an elastic modulus E=193.7 GPa, a Poisson's ratio v=0.3 and a yield strength R_{eL}=203.1 MPa;

In S2, a value of a parameter η representing the structural characteristics of the axially compressed cylinder is calculated.

$$η = \frac{L}{R} \sqrt{\frac{R}{t}} = 22.62$$

In S3, a theoretical value σ_{cr} of an ideal elastic buckling stress of the axially compressed cylinder is calculated according to the value of η in step S2; for a medium-long cylinder with 1.7<η≤0.5R/t, the theoretical value σ_{cr} of the buckling stress is calculated as follows:

$${σ}_{cr} = \frac{0.577}{\sqrt{( 1 - {v}^{2} )}} E \frac{t}{R} = 117 2.3 MPa$$

In S4, a value of parameter γ representing an elastic-plastic behavior of the axially compressed cylinder is calculated.

$$γ = \sqrt{3 ( 1 - {v}^{2} )} \frac{{R}_{e L}}{E \frac{R}{t}}$$

In S5, a critical buckling stress σ_{acr}^{U} of the axially compressed cylinder under different buckling failure modes considering the influence of material elasticity and structural length-diameter ratio is calculated; for a cylinder with elastic-plastic buckling of γ≤0.2, the σ_{acr}^{U} value is calculated according to the following formula.

σ_{acr}^{U}=σ_{cr}·γ=202.8 MPa

In S6, the values of structural characteristic boundary points η_{E} and η_{P} when the cylinder undergoes plastic buckling, elastic-plastic buckling and elastic buckling are calculated;

$${η}_{E} = 0 \text{.832} \cdot \sqrt{\frac{1}{\sqrt{( 1 - {v}^{2} )}} \frac{{L}^{2}}{{R}^{2}} \frac{E}{{R}_{e L}}}$$

$${η}_{P} = 0 \text{.340} \cdot \sqrt{\frac{1}{\sqrt{( 1 - {v}^{2} )}} \frac{{L}^{2}}{{R}^{2}} \frac{E}{{R}_{e L}}}$$

In S7, a buckling stress reduction factor calculation model ρ_{KDF} selected for the cylinder considering the influence of initial defects is judged according to the η value; for a cylinder with η≤η_{P}, ρ_{KDF}=0.9.

In S8, an allowable compressive stress value [σ_{acr}] of the axially compressed cylinder is calculated according to the ideal critical buckling stress σ_{acr}^{U} considering the influence of material elasticity and structural length-diameter ratio, and the critical buckling stress reduction factor ρ_{KDF} and the design safety factor η_{ab} considering the influence of initial defects as follows:

$$[ {σ}_{acr} ] = \frac{{σ}_{acr}^{U} \cdot {ρ}_{KDF}}{{n}_{ab}} = \frac{202.8 \times 0.9}{2} = 9 1.3 MPa$$

The design safety factor n_{ab} is 2.0.

The comparison between the allowable compressive stress design value and the test value of the axially compressed cylinder given in this example is shown in Table 3.

TABLE 3
Comparison of allowable compressive stress design value and
test value of axially compressed cylinder given in this example

| | | Present | ASMEVIII-2 | EN |
|---|---|---|---|---|
| Method | Test | disclosure | Part 4 | 13445-3 |
| Allowable compressive | 191.8 | 91.3 | 81.5 | 82.1 |
| stress value of the | | | | |
| cylinder | | | | |
| Relative error | — | −52.4% | −57.5% | −57.2% |

It should be noted that in the design of cylindrical structures in practical engineering, to ensure the safety of structural design, a safety factor must be introduced into the design method. The allowable compressive stress value of each axially compressed cylinder in Table 3 is the design value given after considering the design safety factor of each method. Taking the present disclosure as an example, by considering the design safety factor n_{ab}=2.0 of the axially compressed cylinder, the error between the design value of the allowable compressive stress of the axially compressed cylinder and the test value exceeds 50%, but this does not mean that the method error is large, but it is an inevitable result after considering the design safety factor.

As can be seen from Table 3, compared with the design methods given by the other two current standards and specifications, the error between the allowable compressive stress design value and the test value of the axially compressed cylinder determined by the present disclosure is the smallest, and the design redundancy is effectively reduced. At the same time, it has enough safety margin and meets the needs of engineering design.

### EXAMPLE 4

Referring to FIG. 1, a design method of allowable compressive stress of an axially compressed cylinder includes the following steps:

In S1, structural characteristic parameters and material performance parameters of the cylinder are determined according to design requirement; the structural characteristic parameters comprise a radius R=179.5 mm, a length L=1878 mm and a thickness t=5.9 mm; the material performance parameters comprise an elastic modulus E=210 GPa, a Poisson's ratio v=0.3 and a yield strength R_{eL}=740 MPa.

In S2, a value of a parameter η representing the structural characteristics of the axially compressed cylinder is calculated.

$$η = \frac{L}{R} \sqrt{\frac{R}{t}} = 57.7$$

In S3, a theoretical value σ_{cr} of an ideal elastic buckling stress of the axially compressed cylinder is calculated according to the value of η in step S2; for a medium-long cylinder with η>0.5R/t, the theoretical value σ_{cr} of the buckling stress is calculated as follows:

$${σ}_{cr} = \frac{0.577}{\sqrt{( 1 - {v}^{2} )}} E \frac{t}{R} \cdot {B}_{x} = 378 8.6 MPa$$

When considering that the two ends of the cylindrical shell are fixed, B_{xb}=6.

$${B}_{x} = max ( 1 + \frac{0.2}{{B}_{xb}} ( 1 - \frac{2 {Lt}^{0.5}}{{R}^{1.5}} ) , 0.6 ) = 0.907 .$$

In S4, a value of parameter γ0 representing an elastic-plastic behavior of the axially compressed cylinder is calculated.

$$γ = \sqrt{3 ( 1 - {v}^{2} )} \frac{{R}_{eL}}{E \frac{R}{t}}$$

In S5, a critical buckling stress σ_{acr}^{U} of the axially compressed cylinder under different buckling failure modes considering the influence of material elasticity and structural length-diameter ratio is calculated; for a cylinder with elastic-plastic buckling of γ≤0.2, the σ_{acr}^{U} value is calculated according to the following formula.

σ_{acr}^{U}=σ_{cr}·γ=671.1 MPa

In S6, the values of structural characteristic boundary points η_{E} and η_{P} when the cylinder undergoes plastic buckling, elastic-plastic buckling and elastic buckling are calculated.

$${η}_{E} = 0 \text{.832} \cdot \sqrt{\frac{1}{\sqrt{( 1 - {v}^{2} )}} \cdot \frac{{L}^{2}}{{R}^{2}} \cdot \frac{E}{{R}_{e L}}}$$

$${η}_{P} = 0 \text{.340} \cdot \sqrt{\frac{1}{\sqrt{( 1 - {v}^{2} )}} \cdot \frac{{L}^{2}}{{R}^{2}} \cdot \frac{E}{{R}_{e L}}}$$

In S7, a buckling stress reduction factor calculation model ρ_{KDF} selected for the cylinder considering the influence of initial defects is judged according to the η value; for a cylinder with η≤η_{P}, ρ_{KDF}=0.9.

In S8, an allowable compressive stress value [σ_{acr}] of the axially compressed cylinder is calculated according to the ideal critical buckling stress σ_{acr}^{U} considering the influence of material elasticity and structural length-diameter ratio, and the critical buckling stress reduction factor ρ_{KDF} and the design safety factor n_{ab} considering the influence of initial defects as follows:

$$[ {σ}_{acr} ] = \frac{{σ}_{acr}^{U} {ρ}_{KDF}}{{n}_{ab}} = \frac{671.1 \times 0.9}{2} = 302. MPa$$

The design safety factor n_{ab} is 2.0.

The comparison between the allowable compressive stress design value and the test value of the axially compressed cylinder given in this example is shown in Table 4.

TABLE 4
Comparison of allowable compressive stress design value and
test value of axially compressed cylinder given in this example

| | | Present | ASMEVIII-2 | EN |
|---|---|---|---|---|
| Method | Test | disclosure | Part 4 | 13445-3 |
| Allowable compressive | 719.1 | 302.0 | 65.0 | 939.7 |
| stress value of the | | | | |
| cylinder | | | | |
| Relative error | — | −58.0% | −77.8% | 30.7% |

It should be noted that in the design of cylindrical structures in practical engineering, to ensure the safety of structural design, a safety factor must be introduced into the design method. The allowable compressive stress value of each axially compressed cylinder in Table 4 is the design value given after considering the design safety factor of each method. Taking the present disclosure as an example, by considering the design safety factor n_{ab}=2.0 of the axially compressed cylinder, the error between the design value of the allowable compressive stress of the axially compressed cylinder and the test value exceeds 50%, but this does not mean that the method error is large, but it is an inevitable result after considering the design safety factor.

As can be seen from Table 4, for the long cylinder with η>0.5R/t the design value of allowable compressive stress of the axially compressed cylinder given by the EN 13445-3 design method greatly exceeds the test value, which has a great design safety hazard. Compared with the design methods given by the other two current standards and specifications, the allowable compressive stress design method of the axially compressed cylinder provided by the present disclosure has the minimum error between the design value and the test value on the premise of ensuring sufficient safety margin and meeting the needs of engineering design and effectively reduces the designed redundancy.

The above is a further detailed description of the present disclosure in combination with the preferred embodiment, and it is not a limitation of the present disclosure. It should be pointed out that any simple deduction and optimization of the present disclosure based on the core idea of the present disclosure shall be regarded as within the protection scope of the present disclosure.

What is claimed is:

1. A design method for an allowable compressive stress of an axially compressed cylinder, comprising the following steps:
S1, determining structural characteristic parameters and material performance parameters of the axially compressed cylinder according to design requirements, wherein the structural characteristic parameters comprise a radius R, a length L and a thickness t, and the material performance parameters comprise an elastic modulus E, a Poisson's ratio v and a yield strength R_{eL};
S2, calculating a value of a parameter η representing structural characteristics of the axially compressed cylinder;
$$η = \frac{L}{R} \sqrt{\frac{R}{t}}$$
S3, calculating a theoretical value σ_{cr} of an ideal elastic buckling stress of the axially compressed cylinder according to the value of η in step S2;
wherein for a short cylinder with η≤1.7, a theoretical value σ_{cr} of the buckling stress is calculated as follows:
$${σ}_{cr} = \frac{0.79 - \frac{1.06}{η} + \frac{1.2}{{η}^{2}}}{\sqrt{( 1 - {v}^{2} )}} E \frac{t}{R}$$
wherein for a medium-long cylinder with 1.7<η≤0.5R/t, a theoretical value σ_{cr} of the buckling stress is calculated as follows:
$${σ}_{cr} = \frac{0.577}{\sqrt{( 1 - {v}^{2} )}} E \frac{t}{R}$$
and
wherein for a long cylinder with η>0.5R/t a theoretical value σ_{cr} of the buckling stress is calculated as follows:
$${σ}_{cr} = \frac{0.577}{\sqrt{( 1 - {v}^{2} )}} E \frac{t}{R} \cdot {B}_{x}$$
$$where {B}_{x} = max ( 1 + \frac{0.2}{{B}_{xb}} ( 1 - \frac{2 {Lt}^{0.5}}{{R}^{1.5}} ) , 0.6 )$$
where B_{xb} is a coefficient considering influence of cylinder boundary conditions;
S4, calculating a value of a parameter γ representing an elastic-plastic behavior of the axially compressed cylinder as follows:
$$γ = \sqrt{3 ( 1 - {v}^{2} )} \frac{{R}_{e L}}{E} \frac{R}{t}$$
S5, calculating a critical buckling stress σ_{acr}^{U} of the axially compressed cylinder under different buckling failure modes, considering influence of material elasticity and structural length-diameter ratio;
wherein for a cylinder with plastic buckling of γ≤0.2, a σ_{acr}^{U} value is calculated as follows:
σ_{acr}^{U}=σ_{cr}·γ
wherein for a cylinder with elastic-plastic buckling of 0.2<γ≤1.2, a σ_{acr}^{U} value is calculated as follows:
σ_{acr}^{U}=σ_{cr}·(−0.01982+1.12391·γ−0.25422·γ²) and
wherein for a cylinder with elastic buckling of γ>1.2, a σ_{acr}^{U} value is calculated as follows:
$${σ}_{acr}^{U} = {σ}_{cr} \cdot ( 1.012 + 2.226 \cdot {e}^{- \frac{η}{2.220}} )$$
S6, calculating values of structural characteristic boundary points η_{E} and η_{P} when the cylinder undergoes plastic buckling, elastic-plastic buckling and elastic buckling;
$${η}_{E} = 0.832 \cdot \sqrt{\frac{1}{\sqrt{( 1 - {v}^{2} )}} \cdot \frac{{L}^{2}}{{R}^{2}} \cdot \frac{E}{{R}_{eL}}}$$
$${η}_{P} = 0.34 \cdot \sqrt{\frac{1}{\sqrt{( 1 - {v}^{2} )}} \cdot \frac{{L}^{2}}{{R}^{2}} \cdot \frac{E}{{R}_{eL}}}$$
S7, determining a buckling stress reduction factor calculation model ρ_{KDF} selected for the cylinder considering the influence of initial defects according to the value of η;
wherein for a cylinder with η>η_{E}, a value of ρ_{KDF} is calculated as follows:
ρ_{KDF}=0.40535+0.60158·e^{-0.06749·η}
wherein a cylinder with η_{P}<η≤η_{E}, a value of ρ_{KDF} is calculated as follows:
$${ρ}_{KDF} = f ( {η}_{E} ) + \frac{{η}_{E} - η}{{η}_{E} - {η}_{P}} [ f ( {η}_{P} ) - f ( {η}_{E} ) ]$$
where ƒ(η_{E})=0.40535+0.60158·e^{-0.06749·η}^{_{E}}; ƒ(η_{P})=0.9; and
wherein for a cylinder with η≤η_{P}, ρ_{KDF}=0.9; and
S8, calculating an allowable compressive stress value [σ_{acr}] of the axially compressed cylinder based on the critical buckling stress σ_{acr}^{U} considering the influence of material elasticity and structural length-diameter ratio, and based on a critical buckling stress reduction factor ρ_{KDF} and a design safety factor n_{ab} considering the influence of initial defects as follows:
$$[ {σ}_{acr} ] = \frac{{σ}_{acr}^{U} \cdot {ρ}_{KDF}}{{n}_{ab}}$$
wherein the design safety factor n_{ab} is 2.0.

2. The design method for the allowable compressive stress of the axially compressed cylinder according to claim 1, wherein in step S3, B_{xb}=1 when both ends of the cylinder are simply supported, B_{xb}=3 when one end is simply supported and the other end of the cylinder is fixedly supported, and B_{xb}=6 when both ends of the cylinder are fixedly supported.

3. The design method for the allowable compressive stress of the axially compressed cylinder according to claim 1, wherein a diameter-thickness ratio range of the cylinder is
$$5 \leq \frac{R}{t} \leq 1200 .$$

4. The design method for the allowable compressive stress of the axially compressed cylinder according to claim 1, wherein a length-diameter ratio range of the cylinder is
$$0.5 \leq \frac{L}{R} \leq 15 .$$

5. The design method for an allowable compressive stress of an axially compressed cylinder according to claim 1, wherein the cylinder is made of a metal material or a composite material.
